(19) United States
(12) Patent Application Publication
(10) Pub. No.: US 2016/0223844 A1
(43) Pub. Date: Aug. 4, 2016

(54) OPTICAL CONTROL ELEMENT

(71) Applicant: Sumitomo Osaka Cement Co., Ltd, Tokyo (JP)

(72) Inventor: Junichiro ICHIKAWA, Tokyo (JP)

(21) Appl. No.: 15/002,511

(22) Filed: Jan. 21, 2016

(30) Foreign Application Priority Data
Jan. 30, 2015 (JP) 2015-016455

(51) Int. Cl. G02F 1/01; G02F 1/225

(52) U.S. Cl. CPC G02F 1/0147; G02F 1/225; G02F 2001/212

(57) ABSTRACT

Provided is an optical control element including a lithium niobate substrate, optical waveguides formed on the substrate, and electrodes for controlling light waves propagating through the optical waveguide, in which a temperature control element for substrate for controlling the temperature of the substrate is provided, and the temperature of the substrate is controlled using the temperature control element for substrate to be maintained at a temperature that is equal to or higher than a predetermined lower limit of temperature at which generation of a photo-refractive effect due to light propagating through the optical waveguide is suppressed and is equal to or lower than 80° C.

The present application claims priority over Japanese Application JP 2015-016455, filed on Jan. 30, 2015, the contents of which are hereby incorporated into this application by reference.

### BACKGROUND OF THE INVENTION

1. Field of the Invention

The present invention relates to an optical control element including an optical waveguide formed on a substrate and a control electrode for controlling light propagating through the optical waveguide, and particularly to an optical control element that is highly resistant to high optical input power.

2. Description of Related Art

In the field of optical communication or optical measurement, an optical control element such as a waveguide-type optical modulator including an optical waveguide formed on a substrate which has an electro-optic effect and a control electrode for controlling light waves propagating through the inside of the optical waveguide is frequently used.

As the above-described optical control element, for example, a Mach-Zehnder (MZ) optical modulator in which lithium niobate (LiNbO₃) (also referred to as “LN”), which is a ferroelectric crystal, is used for a substrate is widely used. The Mach-Zehnder optical modulator includes a Mach-Zehnder optical waveguide constituted with a launch waveguide for introducing light from the outside, a branch waveguide for branching the light introduced into the launch waveguide into two light waves, two parallel waveguides for respectively propagating the two light waves branched through the branch waveguide, a combining waveguide for combining the light waves propagating through the two parallel waveguides, and an output waveguide for outputting the light waves combined using the combining waveguide to the outside. In addition, the Mach-Zehnder optical modulator includes a control electrode for changing and controlling the phases of light waves propagating through the inside of the parallel waveguides using an electro-optic effect.

In the Mach-Zehnder optical modulator, the intensity of light (combined light waves) output from the combining waveguide is modulated by changing the phase difference between two light waves propagating through the two parallel waveguides using the control electrode. That is to say, the light intensity of the combined light is changed between an ON state and an OFF state (zero intensity) by changing the phase difference between 0 and π/2.

However, the phase difference between two light waves propagating through the two parallel waveguides is changed not only in accordance with variation in environmental temperature but also in accordance with duration time of operation, and this change also causes a change in a voltage applied to the control electrode which is required to set the phase difference to a predetermined value (so-called DC drift effect). There are three major factors causing this change. The first factor is a so-called temperature drift which is the phenomenon in which operating status is fluctuated as if the bias voltage is applied to the electrode when a temperature is changed. The second factor is the change which depends on applied time of voltage to the electrode, which is the phenomenon observed in obtaining a required optical output by applying DC voltage to an electrode. The optical output fluctuates in accordance with passing time and changes to the state as if the DC voltage is not applied, that is to say, the effect of an effective bias voltage diminishes. The third factor is a drift attributed to a photo-refractive effect which is also, in some cases, called a DC drift due to light. Wavelength division multiplexing (WDM) long distance optical fiber communication technology requires an assumption of multi-channel optical amplification using an erbium doped fiber amplifier or a Raman amplifier, and the wavelength is mainly a 1550 nm band. In addition, since the WDM optical fiber long-distance communication technique is a system premising the above-described amplification technique, the intensity of light input to the optical modulator is within a range of at most 10 mW to 20 mW. As a light source, a semiconductor laser diode is mainly used.

Meanwhile, the demand for the extension of a transmission distance in an optical communication system is steady, and, in order to increase the intensity of an optical signal output to an optical fiber transmission line from a Mach-Zehnder optical modulator, it is necessary to increase the intensity of light input to the Mach-Zehnder optical modulator.

At the wavelength 1550 nm band used for an optical communication system, it has been reported that, regarding the optical input power endurance of an optical waveguide device using LN, in the time in the order of 100 hours with respect to an incident power of 75 mW, changes in characteristic such as a phase change (effective bias shift), a change in the optical insertion loss, an optical extinction ratio change, and a drive voltage change do not occur (A. R. Beaumont, C. G. Atkins, and R. C. Booth, “Optically induced drift effects in lithium niobate electro-optic waveguide devices operating at a wavelength of 1.51 μm,” Electron. Lett., vol. 20, no. 23, pp. 1260-1261, 1986 (non-patent literature No. 1)). However, in principle, when the intensity of light input to a Mach-Zehnder optical modulator is further increased, the characteristics of an optical material used for the optical modulator are changed, and the change of modulation characteristics of the modulator may be also induced.

As the changes in characteristics brought about by the input of a high optical power, there are a variety of phenomena attributed to the photo-refractive effect (non-patent literature No. 1, V. E. Wood, “Photo-refractive effect in Waveguide,” in Photorefractive Materials and Their Applications II—Topics in Applied Physics, ed. Gunter, P., and J. P. Huignard, Springer 1998 (non-patent literature No. 2), and G. T. Harvey, G. Astfalk, A. Feldblum, and B, Kassahun, “The Photo-refractive effect in Titanium Indiffused Lithium Niobate Optical Directional Coupler at 1.3 μm,” IEEE J. Quantum Electron, vol. QE-22, no. 6, pp. 893 to 946, 1986 (non-patent literature No. 3)). The photo-refractive effect refers to a phenomenon in which, when an optical material is exposed to a high optical power, electrons at the impurity states or the like in the material are excited and moved in the optically exposed region, the moved electrons are trapped in a region that is not optically exposed or a region having a low intensity of light in the optically exposed region, thereby generating an electrostatic field, and the electrostatic field induces a change in the refractive index in the material through an electro-optic effect such as the Pockels effect. Depending on the pattern, place, and the like of the change in the refractive index, a variety of phenomena described in the non-patent literature No. 2 are caused, and changing of optical characteristics examined in the non-patent literature No. 1 is concerned.

There have been only a few reports regarding the optical input power endurance of an LN optical waveguide device or the photo-refractive effect in the communication wavelength band of 1550 nm. In a Mach-Zehnder optical modulator, it is known that, when the refractive index is changed due to the photo-refractive effect in, for example, at least a part of the parallel waveguides, the above-described light-caused DC drift occurs. In a case in which light is launched into a Mach-Zehnder optical modulator, which is formed on an LN substrate using a Ti diffusion method, using a laser as a light source, the DC drift in the optical waveguide is stable for approximately 7 hours at an optical input power of 75 mW (non-patent literature No. 1).

Currently, a number of LN modulator products manufactured by major manufacturers of communication LN modulators have almost similar levels of input rating specifications. Meanwhile, there are not so many literatures, but examples of changes in characteristics attributed to the photo-refractive effect in a communication wavelength band have been reported. It is considered that, in the LN modulator, a variety of characteristics are changed only to a slight extent due to the photo-refractive effect, and the LN modulator is resistant to launching of high-intensity light. However, non-patent literature No. 4 (Y. Fujii, Y. Otsuka, and A. Ikeda, “Lithium Niobate as an Optical Waveguide and Its Application to Integrated Optics,” IEICE Trans. Electron., vol. 90-C, no. 5, pp. 1081 to 1089, 2007) describes, as an evaluation result of a case in which light in the 1550 nm band is used as incident light in a waveguide formed using an annealed proton-exchange method, that the intensity of transmitted light is decreased due to the photo-refractive effect by approximately 10% at a light launching intensity of 100 mW or higher and by nearly 40% at a light launching intensity of 300 mW.

Non-patent literature No. 5 (S. M. Kostritskii, “Photo-refractive effect in LiNbO₃-based integrated-optical circuits at wavelengths of third telecom window,” Applied. Physics, vol. B95, no. 3, pp. 421 to 428. 2009) discloses that, in both an optical waveguide formed using the annealed proton-exchange method and an optical waveguide formed using the Ti diffusion method, the branching ratio in a Y branch waveguide changes or the extinction ratio in an MZ optical waveguide deteriorates due to launching at a light launching intensity of approximately 100 mW or higher. As described above, it is known that, when the optical input power reaches 100 mW or higher, a change in the optical characteristics of an optical waveguide attributed to the photo-refractive effect becomes significant even in the communication wavelength band of 1550 nm and a long-term stable operation cannot be obtained.

In addition, the non-patent literature No. 3 discloses that, in the communication wavelength band of 1310 nm, characteristics change in a directional coupler in which an LN waveguide is used with launching of light of 25 mW or higher. Meanwhile, non-patent literature No. 6 (Betts, G. E., F. J. O'Donnell, and K. G. Ray. “Effect of annealing on photorefractive damage in titanium-indiffused LiNbO₃ modulators.” Photonics Technology Letters, IEEE vol. 6, no. 2 pp. 211 to 213 1994) discloses that changes in the characteristics of an LN waveguide attributed to the photo-refractive effect are not so drastic as that, the bias or extinction ratio of an MZ modulator changes with launching of light of 125 mW or higher, and resistance can be improved by the annealing in the atmosphere of reducing gas. Japanese Laid-open Patent Publication No. 2004-93905 (patent literature No. 1) and Japanese Laid-open Patent Publication No. 2009-244811 (patent literature No. 2) disclose means for suppressing deterioration of characteristics by forming a structure for avoiding two-beam interference in an optical waveguide substrate. The patent literature No. 1 discloses that deterioration of characteristics is a phenomenon occurring at an optical input power of 10 mW or higher while not disclosing any wavelengths.

In a case in which a laser light source having a narrow line width is used in order to improve optical signal quality (for example, the optical signal-to-noise ratio (OSNR)) as in use of high-capacity optical communication, use for optical measurement requiring high precision, or the like in which multilevel modulation (for example, quadrature phase shift keying (QPSK) or orthogonal frequency-division multiplexing (OFDM)), wave number multiplexing modulation, ultra high speed time division multiplexing (TDM), or the like is used as a modulation method, the coherence of output light from the light source is high, and thus the photo-refractive effect is generated with respect to an input of a lower optical power. For example, according to knowledge obtained by the inventors of the present invention through testing, in a case in which a laser diode with a narrow-line width of 10 MHz or lower is used as alight source, a DC drift attributed to the photo-refractive effect can be generated even at an optical input power of 50 mW.

In the related art, it is known that, in order to compensate for a DC drift generated by both a variation in the environmental temperature and duration of operation time, in addition to a high-frequency signal electrode (RF electrode) that applies a voltage for modulating light, an electrode for compensating for the DC drift by controlling the refractive index of the parallel waveguide (bias electrode) is provided as the control electrode provided in the parallel waveguide in a Mach-Zehnder optical modulator (refer to Japanese Laid-open Patent Publication No. H05-224163 (1993-224163) (patent literature No. 3)). In addition, as another constitution, it is known that a heater is formed on the parallel waveguide, and a temperature difference is provided between two parallel waveguides, thereby generating a phase difference so as to compensate for a DC drift (refer to Japanese Laid-open Patent Publication No. H04-29113 (1992-29113) (patent literature No. 4)).

However, both constitutions of the patent literatures No. 3 and No. 4 fail to provide a solution for the reduction or prevention of generation of the photo-refractive effect. Particularly, in the constitution provided with a bias electrode described in the patent literature No. 3, in a case in which high-intensity light is launched, free electrons generated by the photo-refractive effect are easily moved due to a direct current electric field applied by a bias electrode and induce an additional change in the refractive index, whereby the DC drift is increased at an accelerating rate.

### SUMMARY OF THE INVENTION

On the basis of the above-described background, regarding an optical control element in which a lithium niobate substrate is used, there is a desire for realizing a constitution capable of suppressing the generation of a photo-refractive effect during input of a high optical power.

An aspect of the present invention is an optical control element including a lithium niobate substrate, an optical waveguide formed on the substrate, and an electrode for controlling light waves propagating through the optical waveguide. The optical control element is provided with a temperature control element for substrate for controlling the temperature of the substrate, and the temperature of the substrate is controlled using the temperature control element for substrate to be maintained at a temperature that is equal to or higher than a predetermined lower limit of temperature, at which generation of a photo-refractive effect due to light propagating through the optical waveguide is suppressed and is equal to or lower than 80° C.

According to another aspect of the present invention, the predetermined lower limit of temperature is 50° C.

According to still another aspect of the present invention, the optical waveguide is a Mach-Zehnder optical waveguide, a temperature control element for waveguide for controlling the temperature of a parallel waveguide composing the Mach-Zehnder optical waveguide is provided in at least a part of at least one parallel waveguide, and the temperature of the at least one parallel waveguide is changed using the temperature control element for waveguide so as to change the refractive index of the parallel waveguide, thereby compensating for a DC drift generated in the Mach-Zehnder optical waveguide.

According to yet still another aspect of the present invention, the temperature control element for waveguide is a heater constituted with a thin metal film or a Peltier element.

According to yet still another aspect of the present invention, the optical waveguide is a directional coupler type optical waveguide.

According to yet still another aspect of the present invention, the temperature control element for substrate is a heater constituted with a thin metal film or a Peltier element.

### BRIEF DESCRIPTION OF THE DRAWINGS

FIG. 1 is a perspective view illustrating a constitution of a front surface side (surface side on which a waveguide is formed) of a Mach-Zehnder optical modulator according to a first embodiment of the present invention.

FIG. 2 is a perspective view illustrating a constitution of a rear surface side of the Mach-Zehnder optical modulator illustrated in FIG. 1.

FIG. 3 is a perspective view illustrating a constitution of a Mach-Zehnder optical modulator according to a second embodiment of the present invention.

### DETAILED DESCRIPTION OF THE INVENTION

### First Embodiment

Hereinafter, a first embodiment of the present invention will be described with reference to the drawings. In the present embodiment, as an optical control element, a Mach-Zehnder optical modulator formed on an LN substrate will be described.

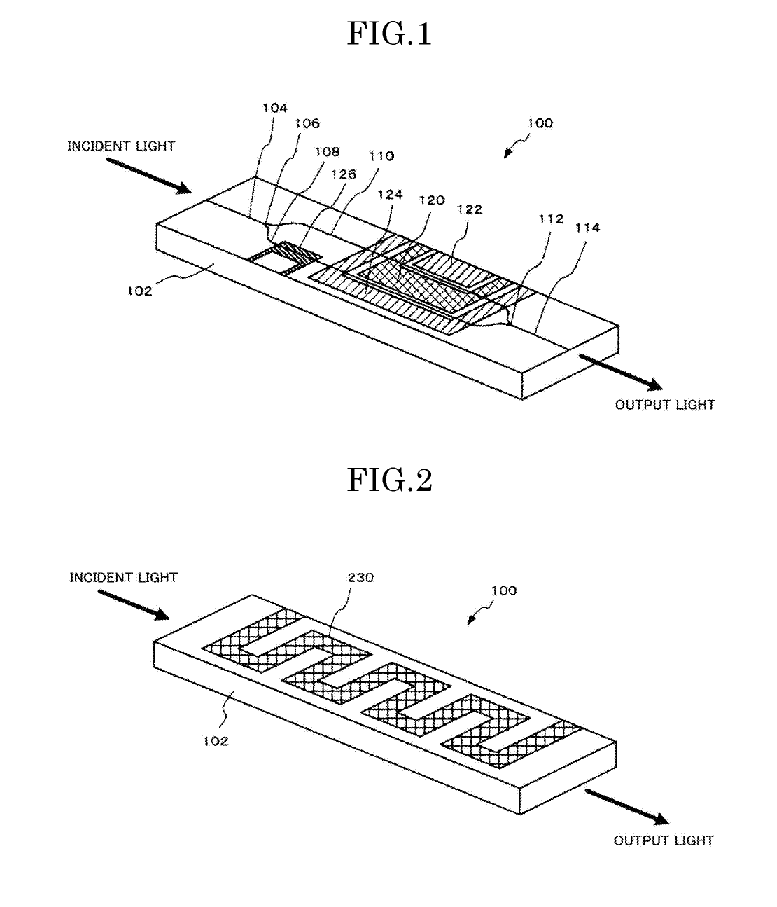

FIG. 1 is a perspective view illustrating the constitution of a front surface side (surface side on which a waveguide is formed) of a Mach-Zehnder optical modulator according to the first embodiment of the present invention.

The present Mach-Zehnder optical modulator 100 is constituted with an LN substrate 102 on which a Mach-Zehnder optical waveguide is formed, and the Mach-Zehnder optical waveguide is constituted with a launch waveguide 104 for receiving incident light, a branch waveguide 106 for branching light propagating through the launch waveguide 104 into two light waves, parallel waveguides 108 and 110 for respectively propagating the two branched light waves, a combining waveguide 112 for combining the light waves from the parallel waveguides 108 and 110, and an output waveguide 114 for outputting the light wave combined in the combining waveguide 112.

In addition, on the LN substrate 102, a high-frequency signal (RF) electrode 120 and ground electrodes 122 and 124 are formed in order to modulate the phase of light propagating through the inside of the two parallel waveguides 108 and 110.

The LN substrate 102 is, for example, an X-cut LN substrate, and thus the RF electrode 120 and the ground electrodes 122 and 124 are disposed so that an electric field is applied in a direction parallel to the surface of the substrate 102 in the parallel waveguides 108 and 110. In the present embodiment, the RF electrode 120 is located between the two parallel waveguides 108 and 110 with a predetermined distance in the longer direction of the parallel waveguides 108 and 110 parallel to the parallel waveguides 108 and 110. In addition, the ground electrodes 122 and 124 are formed parallel to the parallel waveguides 108 and 110 at positions at which the ground electrodes sandwich the parallel waveguides 108 and 110 together with the RF electrode 120.

Furthermore, a heater 126 constituted with a thin metal film is formed in at least a part of the parallel waveguide 108. The heater 126 is a temperature control element for waveguide and compensates for a DC drift by changing the temperature of the part of the parallel waveguide 108 so as to change the refractive index of the part, thereby changing the phase of light propagating through the parallel waveguide 108 so as to control the phase difference between light waves propagating through the parallel waveguides 108 and 110.

The heater 126 is controlled by, for example, being connected to a drift control circuit (not illustrated). The drift control circuit compensates for the DC drift by, for example, superimposing a dither signal on a current supplied to the heater 126 so as to change the phase of light propagating through the parallel waveguide 108 by a predetermined phase value at a predetermined cycle, monitoring a change in the intensity of output light generated as a result of the above-described change using a photo-diode or the like (not illustrated) (by, for example, branching the output light), and controlling the value of the current supplied to the heater 126 (average value) so that the same frequency component as that of the dither signal in the change in the intensity of the output light becomes a minimum.

FIG. 2 is a perspective view illustrating the constitution of the rear surface side of the Mach-Zehnder optical modulator 100. On the rear surface of the LN substrate 102, a heater 230 constituted with a thin metal film is formed. In the Mach-Zehnder optical modulator 100, the temperature of the LN substrate 102 is controlled to be within a range of 50° C. to 80° C. by feeding current to the heater 230. The heater 230 is connected to, for example, a substrate temperature-controlling circuit (not illustrated). The substrate temperature-controlling circuit monitors the temperature of the substrate 102 using, for example, a temperature measurement element (not illustrated) such as a thermistor provided in a certain position on the substrate 102 and controls a current supplied to the heater 230 so that the monitored temperature falls into a range of 50° C. to 80° C. or reaches a predetermined temperature within the range of 50° C. to 80° C.

When the temperature of the LN substrate 102 is increased using the heater 230 and thus falls into the above-described temperature range, the conductivity (mobility of electrons) of LN crystals composing the substrate 102 is increased, and thus the relocation (re-fixing) of electrical charges induced by the photo-refractive effect is prevented, whereby the occurrence of a DC drift-accelerating phenomenon and a variety of other optical phenomena caused by the photo-refractive effect can be prevented.

In the related art, it is known that the activation energy relative to the conductivity of LN crystals is within the range of 0.1 eV to 0.5 eV (Wong, K. K. (Ed.). (2002). Properties of lithium niobate (No. 28). IET.) and the generation of the photo-refractive effect is suppressed by heating the LN substrate to 80° C. or higher so as to increase the conductivity. Therefore, when the LN substrate is heated to 80° C. or higher, the occurrence of the DC drift attributed to the photo-refractive effect is suppressed. However, on the other hand, the acceleration of the DC drift attributed to the increase in the temperature of the LN substrate becomes significant, and consequently, the DC drift is significantly accelerated as the temperature increases.

Therefore, in an optical control element in which the LN substrate is used, considering the trade-off relationship between suppression of the photo-refractive effect due to an increase in the substrate temperature (thereby suppressing the DC drift attributed to the photo-refractive effect) and acceleration of the DC drift attributed to the increase in the temperature, it is absolutely important how to control the temperature range of the LN substrate in order to keep the balance in which both conditions can be endured in practical use.

In a study regarding the generation of the photo-refractive effect in the LN substrate and conditions for avoiding the generation of the photo-refractive effect, the inventors of the present invention found out that the activation energy for the conductivity of the LN crystals, which has been considered to be within the range of 0.1 eV to 0.5 eV in the related art, is within the range of 0.8 eV to 1.2 eV in actual cases. According to an achievement of the present study, for example, regarding incident light having a light power of 100 mW in the communication wavelength band, when the LN substrate is heated to 55° C., it is possible to almost completely avoid the generation of the photo-refractive effect brought about by the incident light. In addition, the inventors of the present invention found out that, on the basis of the above-described study achievement, when the temperature of the LN substrate is set within the range of 50° C. to 80° C., it is possible to reduce both the generation of the photo-refractive effect and the acceleration of the DC drift to the practical level.

The present invention has been made on the basis of the above-described finding, and, in the Mach-Zehnder optical modulator 100 according to the present embodiment, the temperature of the LN substrate 102 is controlled to be within the range of 50° C. to 80° C. using the heater 230 which is the temperature control element for substrate. Therefore, in the Mach-Zehnder optical modulator 100, it is possible to effectively suppress the generation of the photo-refractive effect attributed to launching of a high optical power and also suppress the acceleration of the DC drift caused by an increase in the temperature of the LN substrate 102 (compared with, at least, the temperature of the LN substrate within the range of 80° C. or higher which is required in the related art in order to suppress the photo-refractive effect) to the practical level.

In addition, in the Mach-Zehnder optical modulator 100, the DC drift is compensated for not by applying a direct current electric field to the parallel waveguides 108 and 110 using a bias electrode or the like but by changing the refractive index in at least a part of the parallel waveguide 108 by means of temperature using the heater 126 which is the temperature control element for waveguide provided in the parallel waveguide 108. Therefore, even in a case in which the generation of the photo-refractive effect cannot be completely suppressed by controlling the temperature of the LN substrate 102 using the heater 230, the acceleration of the DC drift that can be generated by a synergy effect between the residual photo-refractive effect and the application of a direct current electric field is prevented.

Meanwhile, in the present embodiment, the heater 126 is directly formed on the substrate 102, but the constitution is not limited thereto, and a buffer layer made of a material such as SiO₂ may be provided between the LN substrate 102 and the heater 126. By this, it is possible to avoid a loss increase due to absorption of light propagating through the parallel waveguide 108 by a metallic material composing the heater 126.

In addition, in the present embodiment, the heater 126 is formed only in a part of one parallel waveguide 108, but the constitution is not limited thereto, and the DC drift may be compensated for by providing a heater in at least a part of the parallel waveguides 110 or providing a heater in at least a part of each of the parallel waveguides 108 and 110.

Furthermore, in the present embodiment, the constitution in which the X-cut LN substrate is used as the LN substrate 102 has been described, but the constitution is not limited thereto, and a Z-cut LN substrate may be used. In this case, the RF electrodes can be respectively formed above the parallel waveguides 108 and 110 with a predetermined distance along the two parallel waveguides 108 and 110, and the ground electrodes can be formed in parallel a predetermined distance away from the RF electrodes so as to sandwich the respective RF electrode from both side portions. In addition, in this case, it is also possible to form a buffer layer formed of a material such as SiO₂ on the LN substrate 102 and form the RF electrode and the ground electrode on the buffer layer. By this, it is possible to avoid a loss due to absorption of light propagating through the parallel waveguides 108 and 110 by a metallic material composing the RF electrode and the ground electrode.

In addition, in the present embodiment, the heater 126 made of a thin metal film is used as the temperature control element for waveguide, but the constitution is not limited thereto, and an arbitrary electro-thermal conversion element can be used. Similarly, in the present embodiment, the heater 230 made of a thin metal film is used as the temperature control element for substrate, but the constitution is not limited thereto, and an arbitrary electro-thermal conversion element can be used. For example, as an electro-thermal conversion element replacing the heaters 126 and 230, a Peltier element can be used.

### Second Embodiment

Next, a Mach-Zehnder optical modulator according to a second embodiment of the present invention will be described. The Mach-Zehnder optical modulator according to the present embodiment has the same constitution as the Mach-Zehnder optical modulator 100 according to the first embodiment except for the fact that Peltier elements are used instead of the heaters 126 and 230.

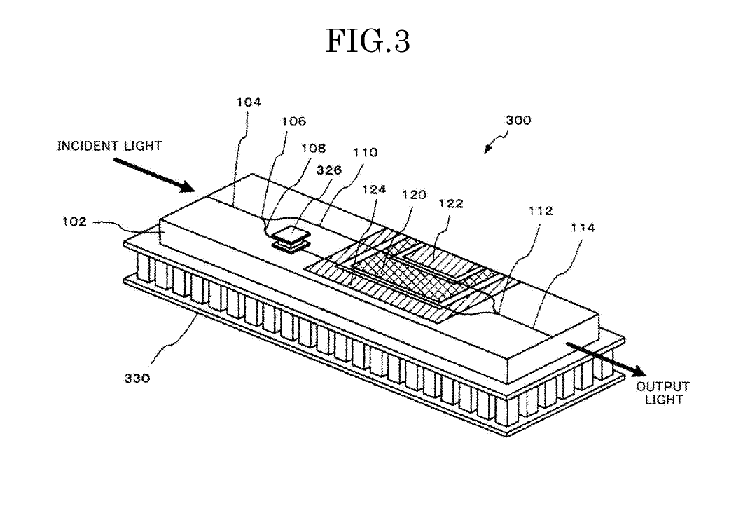

FIG. 3 is a perspective view illustrating the constitution of the Mach-Zehnder optical modulator according to the second embodiment of the present invention. Furthermore, in FIG. 3, the same components as those of the Mach-Zehnder optical modulator 100 illustrated in FIGS. 1 and 2 will be given the same reference signs as those in FIG. 1, and the description of those of the Mach-Zehnder optical modulator 100 will be incorporated herein.

In a Mach-Zehnder optical modulator 300 according to the present embodiment, a Peltier element 326 is provided in a part of the parallel waveguide 108 formed on the substrate 102. The Peltier element 326, similar to the heater 126 in the Mach-Zehnder optical modulator 100 according to the first embodiment, compensates for the DC drift by changing the temperature of a part of the parallel waveguide 108 so as to change the refractive index of the parallel waveguide 108, thereby changing the phase of light propagating through the parallel waveguides 108 so as to control the phase difference between light waves propagating through the parallel waveguides 108 and 110.

The Peltier element 326 is controlled by, for example, being connected to a drift control circuit (not illustrated). The drift control circuit compensates for the DC drift by, for example, superimposing a dither signal on a current supplied to the Peltier element 326 so as to control the value of the current supplied to the Peltier element 326 so that the same frequency component as that of the dither signal in the change in the intensity of the output light output from the output waveguide 114 becomes a minimum.

In addition, the Mach-Zehnder optical modulator 300 includes a Peltier element 330 as the temperature control element for substrate, and the LN substrate 102 is disposed on the Peltier element 330. In the Mach-Zehnder optical modulator 300, the temperature of the LN substrate 102 is controlled to be within the range of 50° C. to 80° C. by feeding current to the Peltier element 330. The Peltier element 330 is connected to, for example, a substrate temperature-controlling circuit (not illustrated). The substrate temperature-controlling circuit monitors the temperature of the substrate 102 using, for example, a temperature measurement element (not illustrated) such as a thermistor provided in a certain position on the substrate 102 and controls the conduction through the Peltier element 330 so that the monitored temperature falls into a range of 50° C. to 80° C. or reaches a predetermined temperature within the range of 50° C. to 80° C.

By this, similar to the Mach-Zehnder optical modulator 100 according to the first embodiment, the Mach-Zehnder optical modulator 300 according to the present embodiment suppresses the generation of the photo-refractive effect and suppresses the generation of the DC drift attributed to the above-described effect by controlling the substrate temperature to be within the range of 50° C. to 80° C. and effectively suppresses the degree of the DC drift so as to cause no practical problem by avoiding the acceleration of the DC drift caused by an excess increase in the substrate temperature. In addition, since the DC drift is compensated for by controlling the temperature without applying a direct current electric field to the parallel waveguide, even in a case in which the generation of the photo-refractive effect cannot be completely suppressed by controlling the substrate temperature, the acceleration of the DC drift that can be generated by a synergy effect between the residual photo-refractive effect and the application of a direct current electric field is prevented.

Meanwhile, the Peltier elements 326 and 330 can be fixed to the LN substrate 102 by, for example, joining the metal film formed in a fixing portion on the LN substrate 102 and metal films formed on fixing surfaces of the Peltier elements 326 and 330 by means of soldering or the like or using an adhesive having favorable thermal conductivity such as a silicone-based adhesive.

Thus far, as described above, in the Mach-Zehnder optical modulators according to the above-described embodiments, the temperature of the LN substrate is controlled to be within the range of 50° C. to 80° C. using the temperature control element for substrate (for example, the heater 230 or the Peltier element 330). Therefore, it is possible to effectively suppress the generation of the photo-refractive effect in a case in which a high optical power is launched into the optical modulator so as to suppress the generation of the DC drift attributed to the above-described effect and to effectively suppress the DC drift so as to cause no practical problem by avoiding an excess increase in the substrate temperature so as to suppress the acceleration phenomenon of the DC drift caused by an increase in the substrate temperature (compared with a case in which a substrate temperature of 80° C. or higher, which is required in the related art to suppress the photo-refractive effect, is employed).

In addition, since not only is the substrate temperature controlled, but the DC drift is also compensated for using the temperature control element for waveguide (for example, the heater 126 or the Peltier element 326) provided in at least a part of the parallel waveguide, even in a case in which the photo-refractive effect is not completely suppressed by controlling the substrate temperature, it is possible to prevent the acceleration of the DC drift that can be generated by a synergy effect between the residual photo-refractive effect and the application of a direct current electric field.

Meanwhile, in the above-described embodiments, the Mach-Zehnder optical modulators have been described as the optical control element, but the optical control element is not limited thereto, and the present invention can be similarly applied to an optical control element in which a Mach-Zehnder optical waveguide or a directional coupler type optical waveguide is used (including not only a optical modulator but also other functional elements such as an optical switch) as well.

What is claimed is:

1. An optical control element comprising:
a lithium niobate substrate;
an optical waveguide formed on the substrate; and
an electrode for controlling light waves propagating through the optical waveguide,
wherein a temperature control element for substrate for controlling the temperature of the substrate is provided, and
the temperature of the substrate is controlled using the temperature control element for substrate to be maintained at a temperature that is equal to or higher than a predetermined lower limit of temperature at which generation of a photo-refractive effect due to light propagating through the optical waveguide is suppressed and is equal to or lower than 80° C.

2. The optical control element according to claim 1,
wherein the predetermined lower limit of temperature is 50° C.

3. The optical control element according to claim 1,
wherein the optical waveguide is a Mach-Zehnder optical waveguide,
a temperature control element for waveguide for controlling the temperature of a parallel waveguide composing the Mach-Zehnder optical waveguide is provided in at least a part of at least one parallel waveguide, and
the temperature of the at least one parallel waveguide is changed using the temperature control element for waveguide so as to change the refractive index of the parallel waveguide, thereby compensating for a DC drift generated in the Mach-Zehnder optical waveguide.

4. The optical control element according to claim 3,
wherein the temperature control element for waveguide is a heater constituted with a thin metal film or a Peltier element.

5. The optical control element according to claim 1,
wherein the optical waveguide is a directional coupler type optical waveguide.

6. The optical control element according to claim 1,
wherein the temperature control element for substrate is a heater constituted with a thin metal film or a Peltier element.

7. The optical control element according to claim 2,
wherein the optical waveguide is a Mach-Zehnder optical waveguide,
a temperature control element for waveguide for controlling the temperature of a parallel waveguide composing the Mach-Zehnder optical waveguide is provided in at least a part of at least one parallel waveguide, and
the temperature of the at least one parallel waveguide is changed using the temperature control element for waveguide so as to change the refractive index of the parallel waveguide, thereby compensating for a DC drift generated in the Mach-Zehnder optical waveguide.

8. The optical control element according to claim 7,
wherein the temperature control element for waveguide is a heater constituted with a thin metal film or a Peltier element.

9. The optical control element according to claim 2,
wherein the optical waveguide is a directional coupler type optical waveguide.

10. The optical control element according to claim 2,
wherein the temperature control element for substrate is a heater constituted with a thin metal film or a Peltier element.

11. The optical control element according to claim 3,
wherein the temperature control element for substrate is a heater constituted with a thin metal film or a Peltier element.

12. The optical control element according to claim 4,
wherein the temperature control element for substrate is a heater constituted with a thin metal film or a Peltier element.

13. The optical control element according to claim 5,
wherein the temperature control element for substrate is a heater constituted with a thin metal film or a Peltier element.

14. The optical control element according to claim 7,
wherein the temperature control element for substrate is a heater constituted with a thin metal film or a Peltier element.

15. The optical control element according to claim 8,
wherein the temperature control element for substrate is a heater constituted with a thin metal film or a Peltier element.

16. The optical control element according to claim 9,
wherein the temperature control element for substrate is a heater constituted with a thin metal film or a Peltier element.
